(19) United States
(12) Patent Application Publication
(10) Pub. No.: US 2004/0265407 A1
(43) Pub. Date: Dec. 30, 2004

(54) Slot die

(76) Inventors: David Neville Prugh, Sayre, PA (US); Lester Ray Brion JR., Monroeton, PA (US)

Correspondence Address: E.I. Du Pont De Nemours and Company, Legal Patent Records Center, 4417 Lancaster Pike, Wilmington, DE, 19805, US

(21) Appl. No.: 10/500,262

(22) PCT Filed: Feb. 5, 2003
(86) PCT No.: PCT/US03/03563

Related U.S. Application Data
(60) Provisional application No. 60/355,072, filed on Feb. 8, 2002.

(51) Int. Cl. A23P 1/00

(52) U.S. Cl. 425/133.5

(57) ABSTRACT

This invention relates to a slot die for forming a coating. More particularly, this invention relates to a die comprising a first plate (46) having a first lip (47), a first location (48), and a second location (49) where the first location (48) is between the second location (49) and the first lip (47); a second plate (51) having a second lip (52), a third location (53), and a fourth location (54) where the third location (53) is between the fourth location (54) and the second lip (52) the second location (49) of the first plate (46) being a distance away from the fourth location (54) of the second plate (51); and a shim (56) having a top seat (57) and a bottom seat (58); the top seat (57) of the shim (56) contacting the first plate (46) at the first location (48) and the bottom seat (58) of the shim (56) contacting the second plate (51) at the third location (53), so as to form a slot (61) in the die (45) which terminates at an orifice (62) and is bounded at the orifice by the first (47) and second lips (52), the first (47) and second lips (52) having a gap there between, the gap having a size (G1); a means for adjustably connecting the first plate (46) to the second plate (51) at the second location (49) and the fourth location (54) such that the size of the gap (G1) between the first (47) and second lips (52) is adjustable by adjusting the distance between the second location (49) of the first plate (46) and the fourth location (54) of the second plate (51).

### BACKGROUND OF THE INVENTION

1. Field of the Invention

This invention relates to slot dies for forming a coating on a substrate and casting films. More particularly, this invention relates to a slot die constructed to control the thickness profile of a coating across the die width, and to the use of that die.

2. Description of Related Art

Slot dies form a flowable material, such as a solvent solution, an emulsion, a thermoplastic melt, a radiation curable oligomer and the like, into a sheet, film, or web. In a common application in the coating industry, a solvent solution of a coating material is moved into an inlet, through an internal distributing cavity, and discharged from an orifice (also known as is an exit) to form a ribbon of material which is coated onto a substrate and concentrated by evaporation to continuously form a supported sheet, film, or web which can be wound into a roll. The die takes a stream of flowable material and spreads it internally to form a discharging ribbon with a large width-to-thickness ratio.

Coatings may also be applied by slot dies to substrates other than continuous webs such as discrete parts or sheets cut from a web which are passed singularly or in arrays through the coating station. After the deposition of a coating, it can remain a fluid such as in the application of lubricating oil to metal in metal coil processing or the application of chemical reactants to activate or chemically transform a substrate surface. Alternatively, the coating can be dried if it contains a volatile fluid to leave behind a solid coat such as a paint, or can be cured or in some other way solidified to a functional coating such as a release coating to which a pressure sensitive adhesive will not aggressively stick.

It is known that different flowable materials processed under a variety of conditions through a slot die can deform a slot die orifice to different extents, producing a ribbon of material of uneven thickness. A highly viscous material coated at a high rate of speed may require high pressure pumping which can generate high pressures within a slot die cavity. High pressures are capable of deforming a slot die, and the pressures are generally not uniform within the cavity. Materials introduced into a slot die cavity at high temperatures can also deform a die orifice from its original shape due to forces generated by dimensional changes in the slot die due to the coefficient of thermal expansion of the slot die.

It is known to provide dies with various manual mechanical, thermomechanical, piezomechanical, magnetostrictive, or motor driven actuators for moving the die lips to provide control of the film, sheet, or coating thickness. This control is produced by controlling the local flow rate of fluid exiting across the width of the die from the slot orifice of the discharge slot at the external surface of the die body by adjusting the orifice gap.

Usually, control is accomplished by measuring the thickness of the film or coating at various points across its width with a thickness gage such as beta-ray, X-ray, or light absorption gage. With the information from such a measurement, an operator can manually adjust a bolt type actuator bearing against the lip. Alternatively, a control system can signal the activation of actuators which bear against the lip or which rotate bolts that bear against the lip. The manual adjustment of die lip flexing bolts by an operator requires skill and experience. It has been shown that the quality of product extruded or coated can be improved by a closed loop control system to replace the manual operator adjustment.

U.S. Pat. No. 5,587,184 (W. K. Leonard, et al.) teaches a method to adjust the die slot orifice gap to produce a controlled flow from the slot orifice across the width of a die by providing movable back seats at the back of the die that cause the front and back portions of the die plates to move simultaneously to produce a change in the die slot orifice gap. At least one actuator is located between the front and back seats of the die to increase or reduce its length to bend the upper plate around the front seat thereby to increase or decrease the die orifice gap.

It is known to provide dies with shims to effect a variety of die slot orifice gap sizes. U.S. Pat. No. 5,894,994 (J. J. Keane, et al.) provides an adjustable slot die which comprises upper and lower die halves secured together and having a replaceable shim of varying thickness there between. Keane et al provides a lip insert adjustment mechanism for adjusting the position of a removable lip insert with respect to the front of a slot die.

U.S. Pat. No. 5,500,274 (D. C. Francis, et al.) provides composite coatings having a variable thickness and a gradient coloration in the cross-web direction using a premetered extrusion coating process wherein a pigmented coating composition and a non-pigmented coating composition are simultaneously extruded onto a carrier film. The composite coatings are useful in preparing laminated structures such as automobile windshields with a colored gradient band.

### SUMMARY OF THE INVENTION

The present invention relates to a die comprising a first plate having a first lip, a first location, and a second location where the first location is between the second location and the first lip; a second plate having a second lip, a third location, and a fourth location where the third location is between the fourth location and the second lip the second location of the first plate being a distance away from the fourth location of the second plate; and a shim having a top seat and a bottom seat; the top seat of the shim contacting the first plate at the first location and the bottom seat of the shim contacting the second plate at the third location, so as to form a slot in the die which terminates at an orifice and is bounded at the orifice by the first and second lips, the first and second lips having a gap there between, the gap having a size; and a means for adjustably connecting the first plate to the second plate at the second location and the fourth location such that the size of the gap between the first and second lips is adjustable by adjusting the distance between the second location of the first plate and the fourth location of the second plate.

### BRIEF DESCRIPTION OF THE DRAWINGS

The invention can be more fully understood from the following detailed description thereof in connection with the accompanying drawings described as follows:

FIG. 1 is a cross-sectional perspective view of a coating die of the prior art.

FIG. 2 is a cross-sectional view of an orifice of each of four coating dies depicted as A, B, C, D, of the prior art.

FIG. 3 is a cross-sectional view of a slot die of the prior art.

FIG. 4 is a perspective view of a first embodiment of a slot die of the present invention.

FIG. 5 is a break-away planar view of a top side of the slot die of FIG. 4.

FIG. 6 is a cross-sectional view of the slot die taken along lines 6-6 of FIG. 4.

FIG. 7 is a cross-sectional view of a second embodiment of the slot die of the present invention.

### DETAILED DESCRIPTION

Throughout the following detailed description, similar reference characters refer to similar elements in all figures of the drawings.

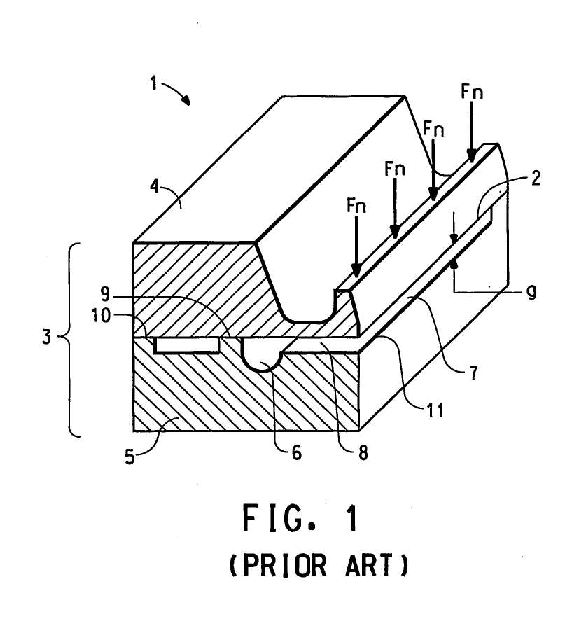

FIG. 1 is a known slot die 1 showing the common features for flexing a top die lip 2 to adjust the profile of the fluid flow from the die across its width. A flowable material is forced to flow into the die body 3, which has a first half or top plate 4 and a second half or bottom plate 5. The material can be distributed within the die using a feature such as a trough 6. The material exits from the die slot orifice 7 (also known as an orifice) of the slot 8. The top plate 4 and bottom plate 5 mate at the middle die seat 9 and rear die seat 10. Adjacent the orifice 7 and on a side opposite the rear die seat 10 are the top die lip 2 and a bottom die lip 11. As is conventional in the art, a plurality of mechanical actuators (not shown) may be used to apply pushing or pulling forces, F₁, F₂, F₃, . . . Fₙ, spaced across the width of the die. These actuators must physically attach to at least one die lip 2, 11 or cause movement of some physical linkage that bears against or is attached to the die lip 2, 11. Known actuators include translating bolts, thermally expanding bolts, piezoelectric actuators, magnetostrictive actuators, motor driven actuators, and hydraulic actuators. Movement by these devices changes an orifice gap 9, also called the orifice height. Non-uniform application of the forces F can produce local changes in the orifice gap g in some limited region across a width of the die 1. Because the local flow rate from the die slot orifice 7 is influenced by the local orifice gap g, the material discharge rate may be adjusted across the horizontal width of the die slot orifice 7 to achieve a given profile of the ribbon of material.

A common profile (also known as a transverse direction cross-section) for the arbitrarily long ribbon of material flowing from the orifice is essentially a rectangle with a constant height determined by the orifice gap g, and a constant width determined by the horizontal width of the orifice 7. The orifice height g is typically small relative to the horizontal width of the orifice 7.

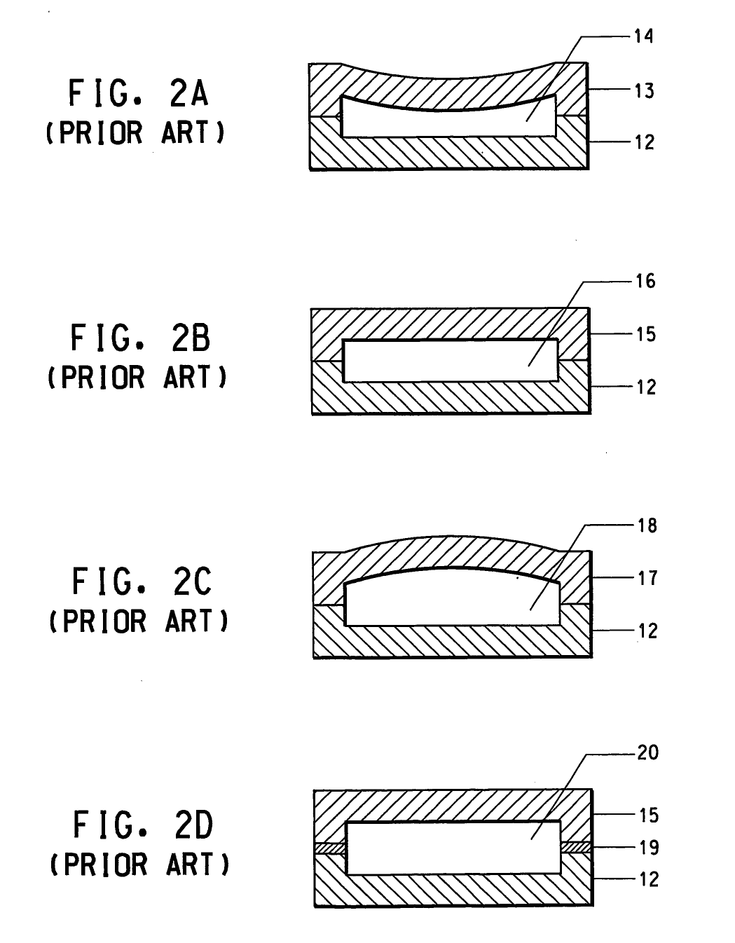

FIG. 2 shows profiles along the orifice of known slot dies. FIG. 2A shows a (lower) flat surface die plate 12 attached to an (upper) convex die plate 13 which form a piano-concave orifice 14. FIG. 2B shows the same (lower) flat surface die plate 12 attached to an (upper) flat surface die plate 15 which form a rectangular orifice 16. FIG. 2C shows the same (lower) flat surface die plate 12 attached to an (upper) concave die plate 17 which form a piano-convex orifice 18. FIG. 2D shows the same (lower) flat surface die plate 12 attached to a shim 19 which is attached to the same (upper) flat surface die plate 15 of FIG. 2B to form a rectangular orifice 20 higher than the orifice shown in FIG. 2B.

Low viscosity material pumped at low temperature and a low rate of ribbon extrusion through a plano-concave orifice might not appreciably change the orifice profile from plano-concave; however if higher viscosity or higher temperature material is used at the same rate of ribbon extrusion, the slot die orifice can deform to form a rectangular or even plano-convex orifice profile. Higher rates of ribbon extrusion, or any combinations of the previously mentioned changes and other well known and commonly experienced changes, can also deform the slot die orifice, for example to form a rectangular or even piano-convex orifice profile from an initially piano-concave profile.

It is desirable to provide conditions to utilize a single set of die plates for extrusion of a wide variety of materials under any of a wide variety of conditions to produce a wide variety of desired ribbon profiles at a wide variety of extrusion rates with only simple adjustments. Such conditions can be described as robust. Because modification of a die plate can be expensive, time-consuming, and irreversible, it is less desirable or even impractical to achieve a wide variety of results by modification of a die plate.

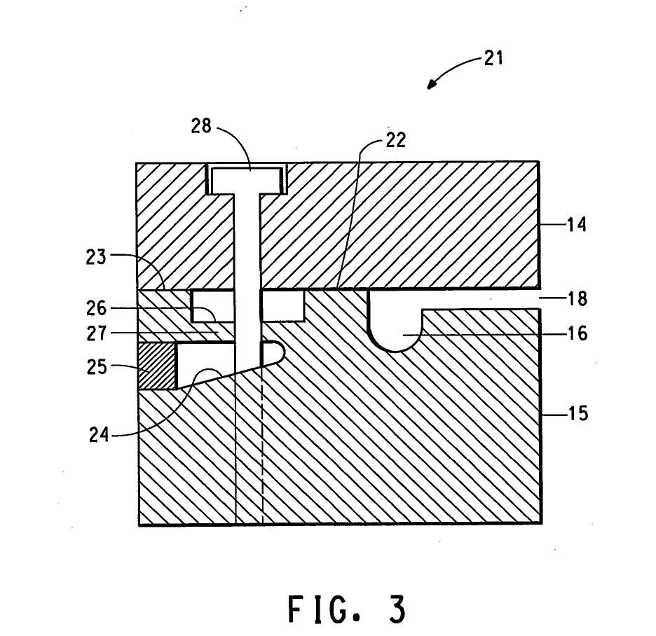

FIG. 3 is a cross section of a prior art slot die. The die body includes a top plate 14 and a bottom plate 15 which contact each other. The top plate mates on the bottom plate at the seats 22, 23, to form a slot 18 with trough 16 through the die body to the right of the seat 22. Flowable material can be forced from the interior of the die body through the slot 18. The slot 18 terminates and is bounded at its orifice by top and bottom lips, which are the ends of the top and bottom plates 14, 15, to the right of the front seat 22.

A cutout 24 is formed in the die plate under the back seat 23 of the bottom plate along at least part of the width of the die. A plurality of means of adjustment or equivalently actuators 25 are inserted into this cutout between a lower actuator seat and an upper actuator seat. The actuators can increase or reduce their length to move the back seat 23 away or toward an actuator seat.

When the actuator 25 lengthens, the top plate 14 at the back seat 23 moves up and pivots around the front seat 22 forcing its top lip downward to close the orifice gap. Similarly, when the actuator 25 shortens, the top plate 14 at the back seat 23 moves down and pivots around the front seat 22 forcing its top lip upward to open the orifice gap. Non-uniform application of only some actuators can produce local changes in the orifice gap in some limited region across the width of the die. In this manner, because the local flow rate from the orifice is influenced by the local gap, the material discharge rate can be adjusted across the width of the die.

An additional cutout 26 is formed on the top of the bottom plate 15 to facilitate the compression. The cutout 26 is bounded by the two seats 22, 23 and a bridge 27. The increase or decrease of the linear distance between the actuator seats, caused by the actuators 25, causes changes in the stresses through all portions of the plates 14, 15 and die bolts 28, and causes the elastic deformation of these pieces. To cause the movement of the top lip relative to the bottom lip to change die orifice gap may require that the bottom plate 15 design allow the front seat 22 to deform elastically while most of the bottom plate 15 remains stiff and relatively unbending. It also requires the die bolts 28 to elastically stretch to avoid impeding movement of the top plate 14 in response to the movement of the actuator 25. Also, the top plate 14 should be rigid and stiff enough so that at least some portion of the movement of the seat 22 in conjunction with the clamping force of the die bolts 28 causes movement of top lip with respect to the bottom lip to change the orifice gap.

The difficulty of producing die plates to these specifications is apparent to those skilled in the art. A single die plate produced to these specifications may not have a desirable level of robustness to produce a range of die orifice profiles. The combination of any two die plates by the teachings known to the art is limited in the range of die orifice profiles which can be practically achieved by the actuators or other methods which are known in the art.

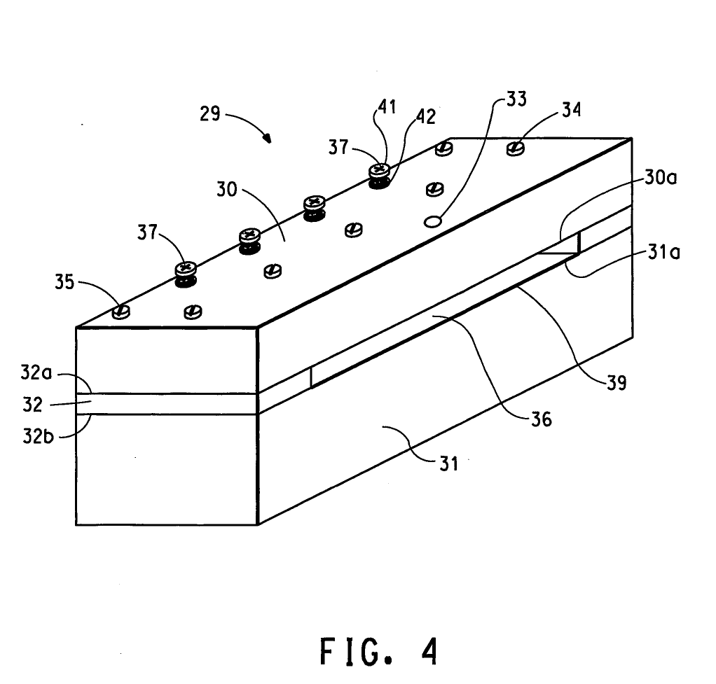

FIG. 4 is a preferred first embodiment of a slot die 29 according to the present invention. The slot die 29 includes a first plate 30 having a first lip 30a, a second plate 31 having a second lip 31a and a shim 32 having a first seat 36 and a second seat 38.

The slot die 29 includes a means of attaching 34 the first plate 30 to the shim 32, and the second plate 31 to the shim 32. In one example, a plurality of connecting bolts and nuts (not shown in FIG. 4) can serve simultaneously as both means of attachment. The means of attaching 34 the second plate 31 to the shim 32 can be independent from or can be the same as the means of attaching 34 the first plate to the shim. In this case, the first plate 31, the shim 32, and the second plate 31 include a plurality of through holes (not shown) which are formed in the first and second plates 30, 31. The through holes can be formed by drilling.

The first plate 30 contacts the shim 32 and the first seat 32a and the second plate 31 contacts the shim 32 and the second seat 32b to form a slot 36 in the die 29 which terminates at an orifice 39 and is bounded at the orifice 39 by the first and second lips 30a, 31a, the first and second lips 30a, 31a having a gap therebetween. The through holes of the first and second plates 30, 31 are placed in alignment with the shim 32 located therebetween. The first and second plates 30, 31 are fastened securely together by a means of attachment 34 which penetrates through the aligned holes.

Flowable material is supplied to the slot die 29 by a material inlet port 33 located in the first plate 30. (The material inlet port could have alternatively been located on the second plate 31 or at any other convenient location.) The flowable material can form a coating, preferably a continuous coating, on a substrate in accordance with any known slot die coating processes.

The slot 36 is adjusted in height by a plurality of means for adjusting 37. The means for adjusting 37 changes the shape of the orifice from the slot 36. The means for adjusting 37 in this illustrative case comprises a compressible spring 40, a spring-holding bolt 41, and an adjusting nut. The spring-holding bolt 41 has a head, a shank and a stop. The compressible spring is positioned above the first plate 30 and the head of the spring-holding bolt 41 is positioned above the compressible spring 40. The shank of the spring-holding bolt 41 extends through the compressible spring 40, a first bore hole (not shown in FIG. 4) of the first plate and at least partially through a second bore hole (not shown in FIG. 4) of the second plate 31. When the spring holding bolt extends fully through the second plate such that a portion of the shank protrudes through the second plate, a nut (not shown) located below the second plate 31 may be fastened to the stop. Thus, each spring-holding bolt 41 can be longer than the combination of the thickness of the first and second plates 30 and 31 and the shim in order to extend out from the slot die. In this embodiment, the compressible spring can be in compression and exerting a force against an outer location of the first plate 30.

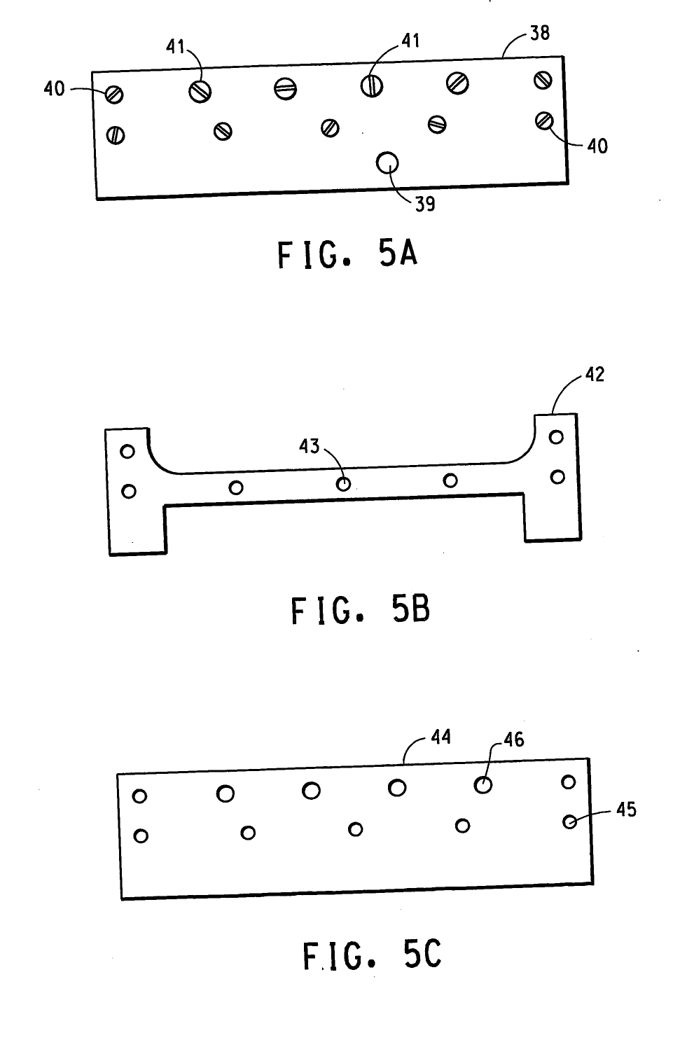

FIG. 5 shows separate top views of the first plate 38 (5A), the shim 42 (5B), and the second plate 44 (5C) as if the die had been disassembled by the removal of all the means of attaching and means for adjusting to better show the upper surface shape of the shim and the second plate. The first plate 38 is penetrated by an inlet port 39 which serves as the material inlet port, a first set of attachment holes 40 (each identified by an imaginary horizonal line within the hole) used to accommodate the means of attaching to hold together the first plate 38, shim 42, and second plate 44; and a first set of adjustment holes 41 (each identified by an imaginary vertical line within the hole) to accommodate the means for adjusting. The first shim 42, has a second set of attachment holes 43 which correspond in position to the first set of attachment holes 40. The second plate 44, has a third set of attachment holes 45 and a second set of adjustment holes 46. The second set of attachment holes 32 are aligned with the first and third sets of attachment holes 40, 45 to accommodate the means of attaching. The first and second sets of adjustment holes 41, 46 are aligned to accommodate the means for adjusting.

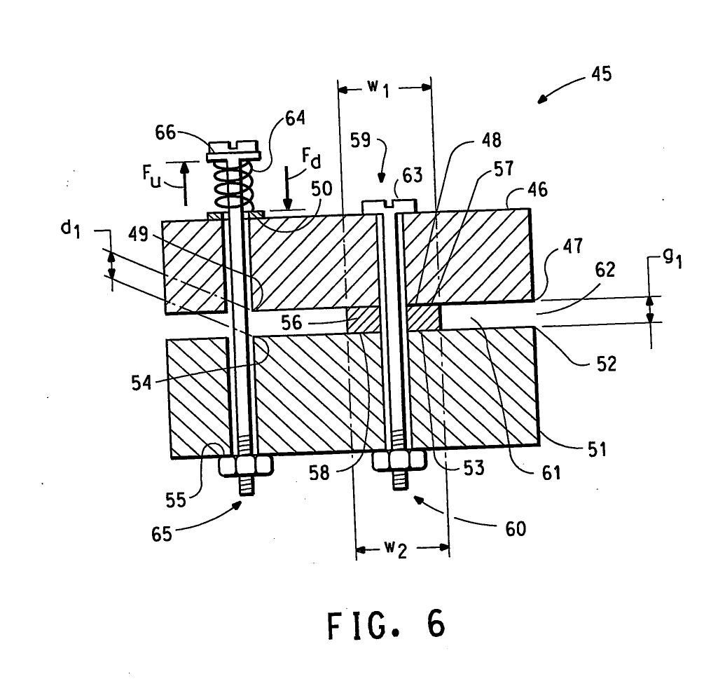

FIG. 6 illustrates in cut-away a preferred embodiment of a slot die 45 of the invention, comprising:

a first plate 46 having a first lip 47, a first inner location 48, a second inner location 49, and a first contacting location 50,

where the first inner location 48 is between the second inner location 49 and the first lip 47;

a second plate 51 having a second lip 52, a third inner location 53, a fourth inner location 54, and a second contacting location 55,

where the third inner location 53 is between the fourth inner location 54 and the second lip 52;

a shim 56 having a first seat 57 with a first seat width w1 and a second seat 58 having a second seat width w2,

a first means of attaching 59 which serves to connect the first plate 46 and the shim 56,

whereby the third means of attaching 59 causes the first plate 46 at the first location 48 to contact

the shim 56 at the first seat 57 along its first seat width w1;

a second means of attaching 60 which serves to connect the second plate 51 and the shim 56,

whereby the fourth means of attaching 60 causes the second plate 51 at the third inner location 53 to contact

the shim 56 at the second seat 58 along its second seat width w2,

such that the shim 56 separates the first plate 46 from the second plate 51 forming a

slot 61 which terminates at an orifice 62 which is bounded at the orifice 62 by the first and second lips 47, 52;

where the orifice 62 defines a first gap height g1 between the first lip 47 and the second lip 52; and

a means of adjusting a first adjustment distance d1 between the second inner location 49 and the fourth inner location 54 such that the first adjustment distance can be lengthened or shortened to adjust, by shortening or lengthening, the first gap height between the first lip 47 and the second lip 52.

A preferred embodiment of the slot die of the invention is exemplified above, wherein the first and second means of attaching both comprise a single set of bolts and nuts 63, and the means of adjusting comprises a plurality of separate assemblies, which comprise

a first spring 64 and a first adjustable coupling member 65, shown here as a third bolt and nut,

where the first spring 64 is configured in contact with the first adjustable coupling member 65, and exerts a first force Fd onto the first plate 46 at the first contacting location 50 and

exerts a second force Fu on the first adjustable coupling member 65 at a coupling member location 66, and the first adjustable coupling member 65 contacts the second plate at the second contacting location 55.

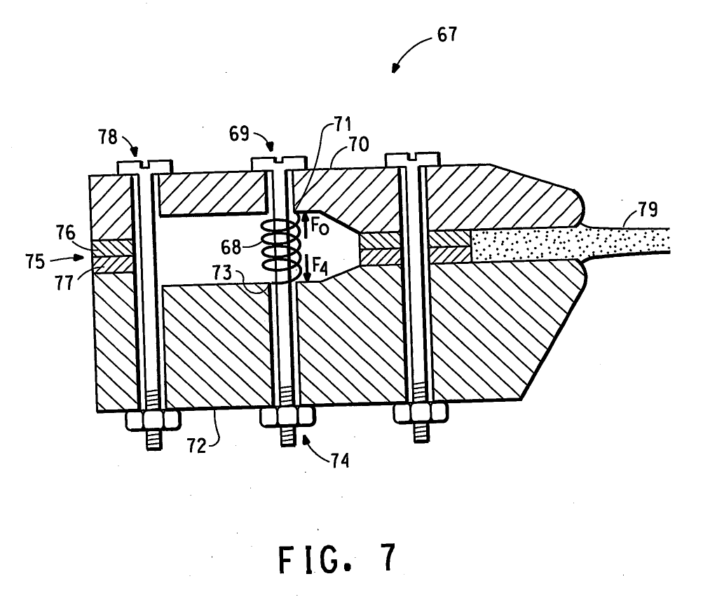

FIG. 7 shows an artist's rendering of a cutaway view of another embodiment of the slot die 67 in the case wherein the means of adjusting comprises

a spring 68 and an adjustable coupling member 69,

where the spring 68 exerts a third force Fo on a first plate 70 at a first contacting location 71 and exerts a fourth force F4 on a second plate 72 at a second contacting location 73, and

the adjustable coupling member 69 comprises for example a plurality of an adjustable assembly of a bolt and a nut 74 which contacts both the first and second plates 70, 71.

FIG. 7 also includes optional features which may be useful. For example, a shim 75 located between the first and second plates 70, 72 opposite the adjustable coupling member comprises a first shim layer 76 and a second shim layer 77. An additional means of attachment 78 is provided and is located between the shim 75 and the adjustable coupling member. A first material 79 is shown flowing from the slot.

In one aspect of the invention a shim is provided which is easily modified or replaced, often more easily and inexpensively than modifying or replacing a plate. A variety of shims can easily be produced which encompass different thicknesses, materials of construction, or physical configurations. For example, either the available thickness or the physical configuration of the shims can easily produce a wide variety of useful orifice configurations (height, width) from a single set of plates.

In another aspect of this invention a shim can be of different thicknesses over the width of the die orifice. If two die plates are of the type shown in FIG. 2B, when used with a shim of constant thickness they will form a rectangular orifice as shown in FIG. 2D. However, if the shim has a changing thickness over its width which is thicker or larger in the center of its width, the orifice produced from the same two plates may be plano-convex or convex (convex on both sides) depending on the bending imparted on the plates by the shim. If the shim has a changing thickness which is thinner or smaller in the center of its width, the orifice produced from the same two plates may be piano-concave or concave (concave on both sides).

Changes of this sort to a slot die can be particularly important if it is desirable to use a single set of plates with coating solutions of low and high viscosity. Major adjustments of the orifice profile across its entire width can easily be accomplished with the shim of this invention, while minor adjustments are carried out with the means of adjustment which modifies the orifice further and locally.

This invention overcomes problems of high material pressure in the slot. That is, when the material flowing to produce the ribbon generates a high pressure and undesirably forces the first plate in known slot dies upwards and the orifice height to increase. This invention also overcomes the problem where the material viscosity is low and the flow rate is low, producing a low pressure in the slot.

Often when a die is assembled and not pressurized, there is a slight deflection of the top half toward the bottom half. The deflection is greatest in the center of the width of the orifice, and there is not deflection at the edges where it is supported by the shim. When a solution is coated with low die pressure (e.g. <10 psig), there can occur what is known as a ‘smile’ profile—a dip in the center and a rise at the edges, also known as a piano-concave profile. This invention overcomes this problem: to raise the front of the die near the center of the coated product.

The shim of this invention is also useful both when the shim separates the two plates at a single region of contact as shown in FIG. 6, or when two or more regions of contact are used, as shown in FIG. 7. A shim which separates the plates at a single region can be useful most particularly when low viscosity materials are used. While two or more regions of contact can stabilize a die orifice against changes in the gap due to coatings of material at high pressures, one region of contact can make a die orifice gap more desirably sensitive to changes in the distance at the remote location caused by the means of adjustment, which is particularly useful for materials coated at low pressures.

As used herein, the term “shim” is intended to encompass a wide variety of constructions which can be placed between two plates in order to separate them. For example, a stacking of two identical shims of the type shown in FIG. 5B would constitute a “shim” for the purposes of this invention. Similarly, if a construction were made from two identical shims coated on all sides by an adhesive, which were then stacked and inserted between two plates, the construction between the plates would be termed a “shim” for the purposes of this invention. Such a shim would have the additional benefit that the adhesive could serve as the means of attachments of the shim to the plates.

Similarly, the material(s) or physical configuration(s) of a shim can easily produce different and useful responses of the gap height to a given change in the adjustment distance. An elastic material of construction may produce a larger response than an inelastic material. Shims constructed by stacking of layers of different material can produce novel and useful responses. Larger seat width(s) may produce a smaller, more adjustable, response.

A shim made of plastic (such as polyethylene terephthalate) or metal (such as stainless steel, or brass) can easily be cut in a pattern which determines the coated width of the applied material. The thickness of the shim (along with a variety of other factors such as those related to the ribbon material (fluid) viscosity, density, and flow rate) determines the pressure drop through the slot length. In one case, dimensions and material properties are as follows:

Fluid density=0.9 g/cc

Fluid viscosity=4 cP

Fluid linear flow=421 cm/sec

Shim=stainless steel, 0.004″ thick

Plates which are useful in the formation of slot dies are well known in the art. Such plates are often made of stainless steel. One type of plate which is useful in the present invention can be purchased from Cloeren Corporation, Orange, Tex.

The control of force with spring compression is much more reproducible than the common means of using bolt torque. Springs which are useful in the present invention can be purchased from McMaster-Carr, Cleveland, Ohio. To improve control of the force applied by the adjusting bolts, heavy-duty compression springs can be inserted between the bolt head and die body. Springs with compression constant of ˜700 lbs/inch are available from McMaster-Carr (part #9624K32 or 962K43 for example). Typical spring compression is 0.25″.

Those skilled in the art, having benefit of the teachings of the present invention as hereinabove set forth, can effect numerous modifications thereto. These modifications are to be construed as being encompassed within the scope of the present invention as set forth in the appended claims.

What is claimed is:

1. A die comprising:
a first plate having a first lip, a first location, and a second location where the first location is between the second location and the first lip;
a second plate having a second lip, a third location, and a fourth location where the third location is between the fourth location and the second lip the second location of the first plate being a distance away from the fourth location of the second plate; and
a shim having a top seat and a bottom seat;
the top seat of the shim contacting the first plate at the first location and the bottom seat of the shim contacting the second plate at the third location, so as to form a slot in the die which terminates at an orifice and is bounded at the orifice by the first and second lips, the first and second lips having a gap there between, the gap having a size;
a means for adjustably connecting the first plate to the second plate at the second location and the fourth location such that the size of the gap between the first and second lips is adjustable by adjusting the distance between the second location of the first plate and the fourth location of the second plate.

2. The die of claim 1 wherein the first plate further comprises a helical spring positioned above the second location and the means for adjustably connecting the first plate to the second plate at the second location and the fourth location comprises a coupling member having a head which is positioned above the helical spring and a fastener which protrudes from the head and extends through the helical spring and the first plate and at least partially through the second plate, so that the head is capable of compressing the helical spring when the head is moved towards the first plate.

3. The die of claim 2 in which the first plate has an outer surface located on a side of the first plate opposite to and above the second location, the spring being located on the outer surface of the first plate.

4. A method for controlling the gap size of a slot orifice gap of a die, the die having
a first plate having a first lip, a first location, and a second location where the first location is between the second location and the first lip;
a second plate having a second lip, a third location, and a fourth location where the second location is between the fourth location and the third lip; and
a shim having a top seat and a bottom seat;
the shim contacting the first plate on the top seat at the first location and contacting the second plate on the bottom seat at the third location, so as to form a slot in the die which terminates at an orifice and is bounded at the orifice by the first and second lips, the first and second lips having a gap there between;
such that the size of the gap between the first and second lips is adjustable by a means of adjustment of a distance between the second location on the first plate and the fourth location on the second plate;
comprising the step of adjusting the means of adjustment to decrease the distance and increase the size of the gap.

5. The method of claim 4 in which the means of adjustment comprises a spring and a coupling member.
